(19) United States
(12) Patent Application Publication
(10) Pub. No.: US 2004/0096327 A1
(43) Pub. Date: May 20, 2004

(54) Method of increasing wind farm energy production

(76) Inventors: Kari Appa, Lake Forest, CA (US); Suri Narayan Appa, Lake Forest, CA (US)

Correspondence Address: Dr. Kari Appa, 22242 Anthony Drive, Lake Forest, CA, 92630-2327, US

(21) Appl. No.: 10/294,339

(22) Filed: Nov. 14, 2002

(51) Int. Cl. F03B 15/06

(52) U.S. Cl. 416/1; 415/4.3

(57) ABSTRACT

A method of enhancing wind farm power production using hybrid wind turbine apparatus includes a pair of counter rotating rotors in tandem. An upright mast supports bearings underlying and rotatably supporting a hub assembly. A first set of rotor is mounted on the windward end of the generator shaft, while the second rotor is mounted on the downwind side of the generator shaft. Three alternate approaches are used to increase power production of a wind farm. One approach uses two turbines assembled in tandem. The second approach uses a conventional high-speed induction generator powered by tandemly mounted contra rotating rotors using suitably designed gearboxes. The third approach uses a specially designed low speed direct drive induction generator powered by tandemly mounted contra rotating rotors without the need of gearboxes. Thus, contra rotating wind turbines can be used to generate more electrical energy and revenue from the same wind farms.

### BACKGROUND OF THE INVENTION

1. Field of the Invention

The present invention relates to a method of enhancing wind farm energy production by designing new wind turbines and retrofitting single rotor turbines with tandem counter rotating rotors in existing wind farms.

2. Description of Prior Art

Most wind turbines use a single rotor system that offers simplicity, reliability and durability. Over the years, improvements have been made to enhance energy conversion efficiency of these single rotor systems. For example, the rotor blades are designed for higher aerodynamic efficiency, the transmission gears are built for low noise and higher power transmission efficiency, and the electrical generators are designed for low copper and iron losses. Despite these improvements, single rotor systems are able to convert only a small fraction of wind stream energy into electrical energy and the remaining wind energy is lost without being harnessed. Since energy-rich wind farms are limited commodities, these sites must be efficiently used to maximize their energy production capacity.

In 1926, Albert Betz estimated that the maximum wind power conversion efficiency of a single rotor system could be as high as 59% if the axial velocity across it could be reduced by ⅔ (Ref.1). In 1942 another investigator, Walter Just, used two rotors in tandem and estimated the power conversion efficiency of two rotors could be increased to 64% (Ref.2). Just also used the same axial velocity change criterion across two rotors, but did not account for the energy content of the tangential velocity component. Since the ⅔^{rd} velocity reduction criterion is difficult to enforce in practice, most wind turbines hardly achieve 40 percent of power conversion efficiency.

The primary reason for this was illustrated by Charles Gordon Curtis as early as in 1896 (Ref.3). Curtis had realized that it was difficult to achieve large changes in enthalpy (velocity) across a single rotor. Therefore, he used the principle of velocity compounding with multiple rotors in tandem on a common shaft and estimated the energy conversion efficiency to be around 75 to 85%. It took 13 years for Curtis' idea to be accepted by the industry. Finally, in 1903 General Electric funded Curtis to build the first American 500 kW steam turbine, which became a landmark invention in power generation.

A number of patents have tried to increase the energy production of wind turbines. U.S. Pat. No. 5,419,683 to Peace discloses a method of installing plurality of wind turbines on chimneys, towers or the like. Two rotors having their horizontal axes were mounted back to back on a ring that turns about the chimney. The primary concept of this invention is to utilize existing tall structures to mount plurality of wind turbines and to reduce the need for wind farms.

The authors of this invention built several contra-rotating wind turbine models and conducted wind tunnel and field tests. The studies have shown that the contra-rotating rotors in tandem could convert additional 30 to 40 percent of wind energy into electrical energy compared to a corresponding single rotor system (Ref. 7). These studies led Appa to the develop multiple versions of contra-rotating wind turbine concepts to enhance wind power conversion efficiency. He has been issued two U.S. Pat. Nos. 6,127,739 and 6,278,197 B1, for his work. In addition, a third U.S. patent based on the application Ser. No. 09/894345, has recently been accepted.

It was with the knowledge of the foregoing state of the technology that the present invention has been conceived and is now reduced to practice. The contra-rotating rotors system in tandem, embodied by this invention is different from all the devices reviewed above. Furthermore, this system can be easily retrofitted to existing single rotor systems without significant alterations in the design.

### REFERENCES

1. Betz, A., Wind-Energie und Ihre Ausnutzung durch Windmuehlen, Vandenhoeck & Ruprecht, Goettingen 1926.

2. Just, W., and Noetzlin, U., Section II: “Leistungsbetrachtungen ueber die verschiedenen Arten von Windmotoren (Strahitheorie),” Denkschrift 7; Arbeiten der Reichsarbeitsgemeinschaft, “Windkraft,” im Geschaeftjahr 1942-1943, Berlin-Steglitz, 12. Jul. 1943.

3. “The First 500 Kilowatt Curtis Vertical Steam Turbine, New Port Rode Island, February 1903,” An International Historic Mechanical Engineering Landmark, Jul. 23, 1990, published by American Society of Mechanical Engineers.

4. Kari Appa, “Jet Assisted Counter Rotating Wind Turbine”. U.S. Pat. No. 6,127,739, Oct. 3, 2000.

5. Kari Appa, “Contra-Rotating Wind Turbine System”. U.S. Pat. No. 6,278,197 B1, Aug. 21, 2001

6. Kari Appa, “Jet Assisted Hybrid Wind Turbine System”, (in Pending, Jc996 U.S. PTO 09/894345, submitted Jun. 28, 2001) now allowed and issuance fee has been paid.

7. Kari Appa, “COUNTER ROTATING WIND TURBINE SYSTEM,” April 2002, Final Report Submitted to California Energy Commission.

### SUMMARY OF THE INVENTION

The present invention is designed to enhance wind farm energy production with the use of contra-rotating wind turbines. The electrical energy production is directly related to Farm Power Density (FPD), a parameter introduced in this invention to describe the efficiency of a wind farm. FPD is defined as the electrical power produced with respect to area. It can be described in terms of megawatts per square kilometer (MW/km²) or megawatts per acre (MW/acre). In order to maximize FPD, each turbine must not only provide a high power conversion efficiency, but also occupy minimal area of the wind farm. Turbines that have large rotor diameters although may produce adequate power, they occupy a greater area, thereby limiting the FPD.

Computation of Wind Farm Power Density:

Consider a wind farm measuring 1000×1000 meters in the wind stream direction. The required spacing between turbines can be calculated as follows:

Spacing in lateral direction=mD

Spacing in wind direction=nD

in which D is the diameter of the rotor and m and n are spacing constants depending on the aerodynamic characteristics of the rotor.

The number of turbines (N) in a kilometer square farm can then be determined:

N=10⁶/(m×n×D²) (1)

Then the wind farm power density (FPD) is given by,

FPD=N*(πD²/4)*p=(π*10⁶)/(4 mn)*p (watts/km²)

or

FPD=(π/4 mn)*p (MW/km²) (2)

where, p is the rotor power density in watts/m².

The wind farm power density, as shown in Equation (2) is not directly related to the rotor diameter, but to turbine spacing (m, n) and the rotor power density. Since spacing parameters m and n are fixed by the aerodynamic performance considerations, the wind farm density is then directly related to the rotor power density p. If a novel approach is used to increase the rotor power density, then it is possible to enhance the wind farm power production and its revenue. Such a novel approach is discussed next.

Power Density of a Dual Rotor System:

To achieve higher rotor power density, the authors of this invention built several configurations of the contra-rotating wind turbine system and conducted both wind tunnel and field tests. Detailed discussions of the study are presented in a report prepared for the California Energy Commission (Ref. 7). A typical example of the contra-rotor system is presented in FIG. 1, which shows the erection process of a contra-rotating wind turbine system at Oak Creek Energy Systems field test facility, Mojave Calif.

FIG. 2 shows the measured electrical power output by the windward rotor 1 and the leeward rotor 2. The net power output is shown as the sum of the power from rotor 1 and rotor 2. The net power, in FIG. 2, is seen to be 30 to 40 per cent more than that produced by the single rotor system. FIG. 3 further illustrates achievable contra-rotor power coefficient or the conversion efficiency factor at various wind speeds. The power coefficient is a measure of wind power conversion efficiency of a wind turbine. The net rotor power coefficient of a contra-rotating system is again, seen to be 30 to 40 per cent higher than that of a single rotor system. Especially at low rotor speeds, such as in the case of large utility scale wind turbines, the power coefficient is seen to exceed 0.72, whereas Betz's theoretical estimation for a single rotor is limited to 0.59 (practical achievable efficiency=0.4). This study suggests that the wind stream behind the first rotor carries significant amount of energy, which is available for conversion. This improvement could increase profit to the utility providers by millions of dollars per year.

Said method of increasing wind farm power production comprises:

1. plurality of contra-rotating wind turbines having;

2. a pair of contra-rotating rotors with their blade angles set to rotate in opposite directions,

3. a larger leeward rotor with its plane of rotation set further back from the yaw axis to provide self aligning characteristics,

4. an electrical generator driven by a pair of contra-rotating rotors,

5. a pair of planetary gears that couple low speed rotors and the high speed generator shaft,

6. a light duty yaw servomotor,

7. an emergency braking device,

8. a shaft adapter needed to transmit power from the contra rotating leeward rotor,

9. a mast to support the wind turbine assembly and other accessories.

This invention suggests three ways of incorporating the counter rotating system in a wind farm to increase its power production:

1. Dual Wind Turbines in Tandem:

This approach uses two wind turbines assembled back to back in tandem such that their rotors spin in opposite direction to each other. This concept can readily be used to retrofit existing wind farms in place of single rotor systems.

2. Single Generator Having Dual Wound Armature Coils:

A single induction generator could be driven by two contra-rotating rotors. Most utility scale generators are provided with dual wound armatures so that the same unit can be used in low wind and high wind seasons to generate energy efficiently with reduced copper and iron losses. This unit can be retrofitted with two contra-rotating rotors to produce more energy using both sets of windings as needed.

3. Direct Drive Induction Generator:

There is the provision to use direct drive generators without the need of gearboxes but requiring only an adaptor that couples the counter-rotating leeward rotor to the generator shaft so that two rotors could drive the same generator.

4. Peripherally Mounted Jets:

There is the provision to use small jet engines (not shown) mounted at the blade tips to produce constant level of power during no wind or low wind conditions without the need for auxiliary power generating units.

Other features and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and together with the description, serve to explain the principles of the invention in general terms. Like numerals refer to like parts throughout the disclosure.

### BRIEF DESCRIPTION OF THE DRAWINGS

The foregoing aspects and other features of the present invention are explained in the following description, taken in connection with the accompanying drawings, wherein:

1. Title of the Drawings

FIG. 1 is a perspective view of a contra-rotating wind turbine system being erected at test site,

FIG. 2 is the plot of power curves of single rotor and contra-rotating wind turbine units including theoretical predictions,

FIG. 3 is the plot of power coefficients of individual rotors and the net power coefficient of the contra-rotating system,

FIG. 4 is a typical configuration of a contra-rotating system comprising dual generators in tandem for improving wind farm energy production,

FIG. 5 is a typical configuration of a contra-rotating system comprising a single induction generator for improving wind farm energy production,

FIG. 6 is another configuration a contra-rotating system comprising a direct drive induction generator for improving wind farm energy production without the use of gearboxes.

### 2 REFERENCE NUMERALS

10 a perspective view of dual generator wind turbine system

11 windward rotor

12 leeward rotor

13 generator

15 disc brake

16 standard planetary gear having opposite input and output shaft rotation

17 planetary gear having input and output shaft rotation in the same direction

18 mast

19 swivel base mount including the assembly of yaw servo and braking system

20 denotes wind direction

21 denotes direction of windward rotor

22 denotes direction of leeward rotor

23 windward rotor shaft

24 leeward rotor shaft

25 an adapter that changes the shaft rotational direction, used in direct drive generators for receiving power from contra-rotating rotors

30 a perspective view of a contra-rotating wind turbine using induction generator

40 a perspective view of a contra-rotating wind turbine using single direct drive (induction or permanent magnet) generator

41 direct drive induction generator

### DETAILED DESCRIPTION OF THE PREFERRED EMBODIMENT

The novel features believed characteristic of this invention are set forth in the appended claims. The invention itself, however, may be best understood and its objects and advantages best appreciated by reference to the detailed description below in connection with the accompanying drawings.

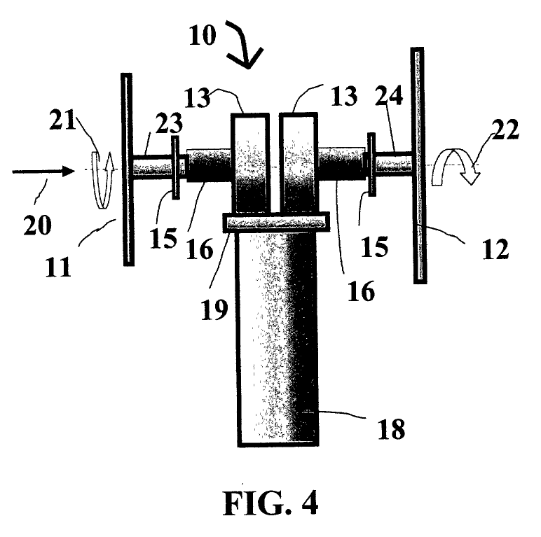

Referring now to FIGS. 4, 5 and 6, there are shown three alternate perspective views of the contra-rotating wind turbine systems 10, 30 and 40 incorporating the features of this invention for efficient use of wind farms to produce more power. Although the present invention will be described with reference to three embodiments shown in the drawings, it should be understood that the present invention could be embodied in many alternate forms or embodiments. In addition, any suitable size, shape or type of elements or materials could be used.

In FIG. 4, the wind turbine apparatus 10 is seen to include two rotor assemblies 11, 12 two alternators 13, an upright mast 18 supporting the turbine assembly base 19 including front and rare rotor gear boxes 16. The leeward (downwind) rotor blades 12 are generally longer than the upwind rotor blades 11 and its hub is placed farther downstream from the vertical axis so that the system can self align to the wind as the wind changes its direction. The self-aligning feature results from larger leeward rotor drag and longer lever arm from its plane of rotation. Consequently, a light duty servomotor is sufficient to position the system aligned to the wind. Two disc brakes 15 are provided on the low speed rotor shafts 23, 24 to shut down the system for servicing or in high-speed wind conditions. The arrow 20 denotes the wind direction, while arrows, 21 and 22 denote the rotational direction of the front and rear rotors respectively.

Certain communities that are far removed from accessible grid power source, a self-sustaining wind farm could be established by the use of small jet engines (not shown) mounted at the tip of the blades of rotors 11 and 12 to drive the generator during low wind or no wind conditions. Detailed discussion of this innovation is disclosed in a forth-coming US patent issued to Appa (Ref. 6).

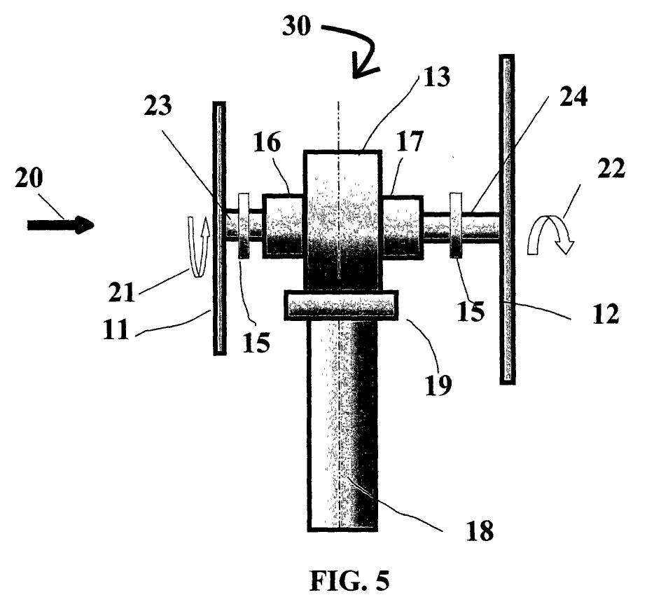

In FIG. 5, is seen an alternate arrangement using a single generator 13 driven by two contra-rotating rotors 11, 12. The slowly spinning windward rotor 11 is coupled to the gear boxes 16, generally of a planetary type. The high-speed end of said gearbox is coupled to the windward end of the generator shaft. The leeward end of the generator shaft is coupled to the high-speed end of a specially designed gear box 17, while the low speed end of said gearbox is coupled to said leeward rotor. Once again, the subassemblies comprising rotors, generator, gear boxes and servo control units are arranged in such a way that the mass center lies slightly towards the downwind direction to render the self aligning feature of the contra-rotating wind turbine system and is guaranteed to be statically and dynamically stable. Once again said jet assisted hybrid configuration can also be implemented with this system.

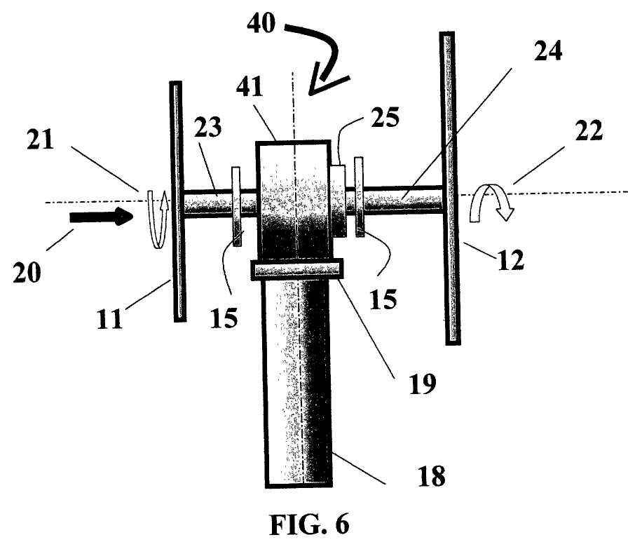

FIG. 6 shows still another alternative arrangement of the tandem rotors 11, 12 that drive a specially designed low speed direct drive generator 41. The slowly spinning windward rotor 11 is directly coupled to the windward end of the generator shaft 23. While the leeward end of the generator shaft 24 is first coupled to an adapter 25, which in turn is coupled to the leeward rotor 12. Once again, the subassemblies comprising rotors, generator, and servo control units are arranged in such a way that the mass center lies slightly towards the downwind direction so that the self aligning feature of the contra-rotating wind turbine system is guaranteed to be statically and dynamically stable. Said jet assisted hybrid configuration can also be implemented with the direct drive generator system.

Let us now consider the theoretical aspects of the invention, which demonstrates the benefits of contra-rotating tandem rotors in improving wind farm energy production and revenue at reduced cost.

The contra-rotating wind turbine system though looked into never went beyond paper work. The main reason could be that by extending the rotor diameter the same extra power could be produced without the need for a complex configuration. This may hold true for a single tower in an open field, but it is not the best way to maximize the efficiency of an energy-rich wind farm.

For an energy rich wind farm, which is a rare commodity, its full utilization becomes a very demanding factor. Energy production and revenue depends on wind farm power density (i.e. Megawatts per square kilometer or acre). If large diameter rotors are used, there will be fewer rotors (since 5 to 8 diameter spacing limits number of rotors) per acre resulting in no extra power. Hence, the tandem rotor arrangement helps to increase farm power density. Consequently, more power and revenue can be produced from the same wind farm. A brief discussion is presented next.

Wind Farm Power Density Analysis:

The present invention introduces a new terminology, “Farm Power Density or FPD as an acronym,” which denotes a measure of wind energy utilization of a wind farm. FPD is defined as mega watts per kilometer square, (MW/km²). Consider a wind farm measuring 1000 meters wide and 1000 meters long in the wind stream direction. Let, mD and nD be the wind turbine spacing in lateral and longitudinal directions respectively, where D is the diameter of the rotor in meters.

Then, the number of turbines that can be installed in a kilometer square farm is,

N=10⁶/(mnD²) (1)

The wind farm power density is then given by,

P=N*(πD²/4)*p=(π*10⁶)/(4 mn)*p watts per km².

Or

P=(π/4 mn)*p mega watt/km² (MW/km²) (2)

where, p is the rotor power density in watts/m².

The wind farm power density, as shown in Equation (2) is not directly related to the rotor diameter, but its spacing (m, n) and the rotor power density, p. The turbine spacing (m, n) is primarily a fixed quantity based on the aerodynamic characteristics of the rotors. Thus, it is seen that the wind farm power density is directly proportional to the rotor power density; p. If a novel approach is used to increase the rotor power density, then it is possible to enhance the wind farm power production and its revenue. Such a novel approach is discussed next.

Power Density of Contra Rotating Rotor by Field Tests:

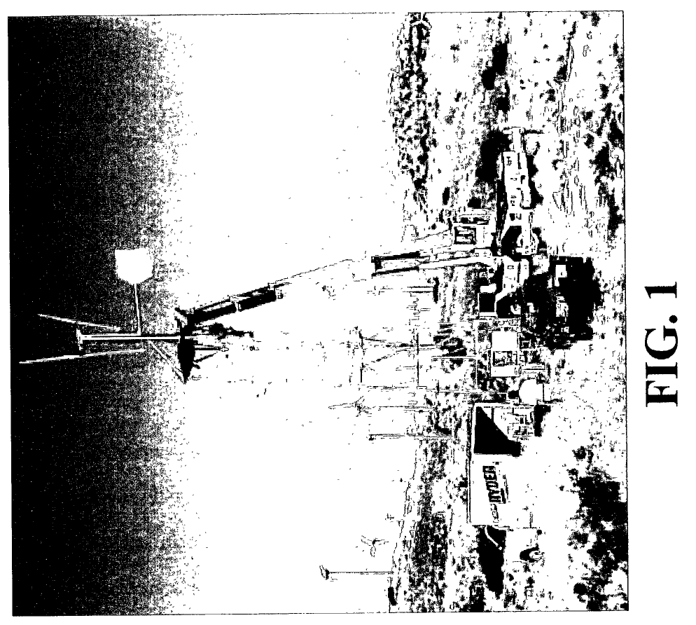

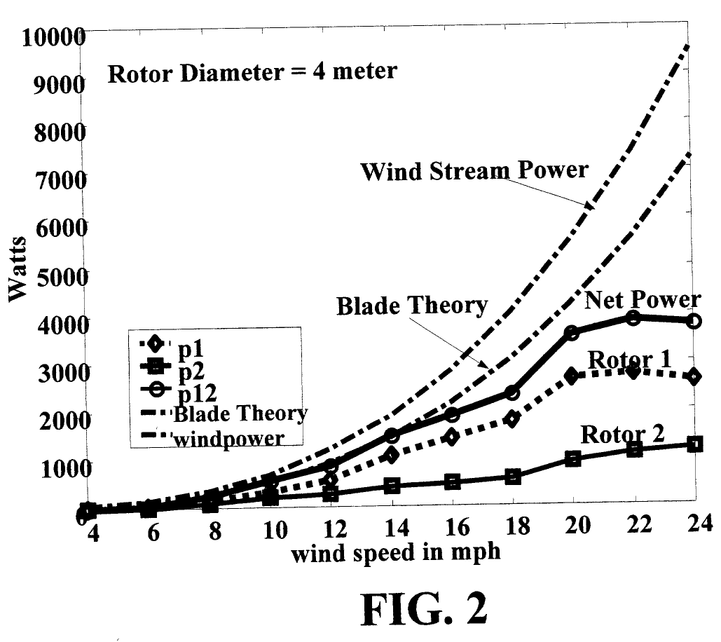

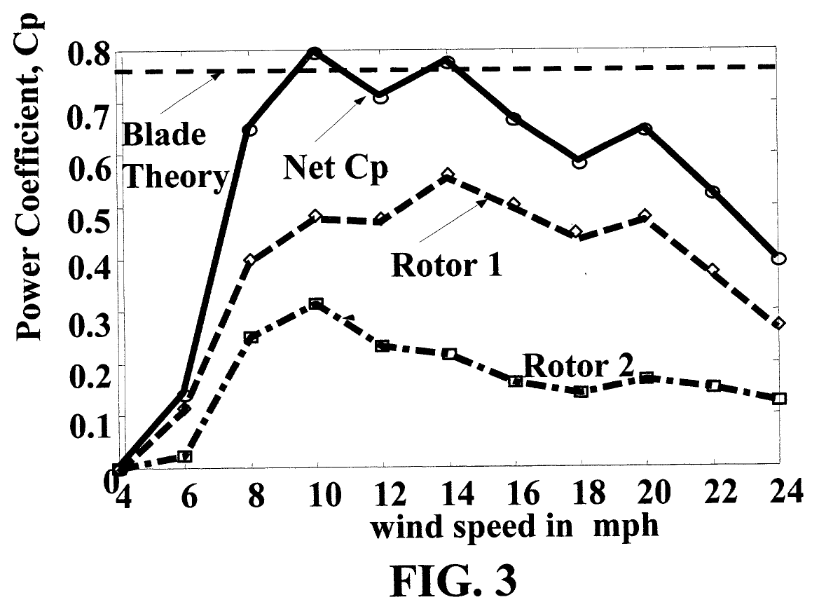

In a recent study funded by the California Energy Commission under Grant No. 51809A/00-09, a contra rotating wind turbine model was built (FIG. 1) and the concept feasibility was demonstrated by field-tests. FIG. 2 summarizes the field test data in terms of power curves derived from two rotors. A theoretical analysis using the elementary blade theory as well as the wind stream power data are also shown for comparison with the field test results. The field test data are seen to agree well with the blade theory prediction up to wind speeds less than 16 mph. At higher speeds the blades might have stalled and hence the departure. FIG. 3 shows the power coefficient (a measure of power conversion efficiency) distribution for each rotor and the net power coefficient. The rear rotor power coefficient is seen to be in excess of 40% of first rotor power. Especially at low rotor speeds, the net power coefficient is seen to be around 72%, which is 13% higher than Betz's prediction of a single rotor case (Ref.1), and 8% higher than Jest's two-rotor momentum theory (Ref. 2). In general, the leeward rotor is seen to produce more than 40% of power at slow rotor speeds. This fact suggests that the velocity compounding by contra-rotation is seen to be more beneficial to utility scale mega watt wind turbines that turn slowly at 16 to 20 rpm. In that case, we may expect even better than 40% power enhancement. Thus, the contra-rotating tandem rotor wind turbine system has demonstrated that the rotor power density is 30 to 40 per cent more than that of a single rotor system. Since from equation 2 the wind farm power density is directly proportional to rotor power density, the wind farm power production and revenue could be increased by 30 to 40 per cent with the tandem rotor arrangement. Thus, the power density of the contra-rotating wind turbine is given by,

p(contra rotor)=1.4*p(single rotor) (3)

With this amount of energy produced in a wind farm, the retrofit cost could then be recovered in 3 to 5 years.

Another interesting observation of these field tests was that the well-known buffeting phenomena did not occur. One possible reason could be that the leeward rotor running in opposite direction might have swept away the vortices. Thus, the anticipated blade vibration may have been avoided.

From the foregoing, consider some of the advantages of the proposed wind turbine system over the known single rotor system:

1. these innovations disclosed here are expected to increase the wind farm energy production by 30 to 40 per cent more than similar single rotor units,

2. dual tandem rotor assembly is expected to reduce stress levels on the supporting structure due to torque load balancing and counter weighting rotor loads,

3. the dual rotor system posses naturally self aligning stability characteristics,

4. jet assisted hybrid wind turbine system is self sustaining unit requiring no auxiliary power system,

5. Buffeting phenomenon is seen to be alleviated due to contra-rotation of the vortices.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. A method of increasing wind farm energy production comprising:
an assembly of tandemly mounted contra-rotating rotors having plurality of blades ranging from one, two or three blades per rotor;
an electrical generator (possibly dual generators) driven by two contra-rotating rotors;
said rotors and said generator coupled by means of gears, an upright mast; and
a yaw bearing on the upright mast underlying the hub assembly for rotatably supporting the hub assembly enabling it to be selectively positioned in azimuth so that the first set of rotor blades are relatively closer to the wind-induced air flow, or upwind, and the second set of rotor blades are relatively farther from the wind-induced air flow, or leeward or downwind,
a light duty yaw control servomotor due to self aligning nature of the contra rotating rotors,
thereby generating electrical power as the upwind rotor and downwind rotor rotate in opposite directions to each.

2. A method of increasing wind farm energy production as set forth in claim 1 wherein the power conversion efficiency of contra rotors is substantially higher than that of a similarly configured single rotor system.

3. A method of increasing wind farm energy production as set forth in claim 1, wherein plurality of contra rotating rotor systems having:
two wind turbines assembled in tandem with rotors set to rotate in opposite direction to each other, and a second approach using a single high speed generator powered by two contra rotating rotors coupled with suitably designed gearboxes, and still another approach using
a specially designed low speed direct drive generator powered by said contra rotating rotors directly coupled to said generator shaft, wherein the leeward rotor and downwind end of said generator shaft coupled by means of an adapter providing power transmission from said rotor to said generator.

4. A method of increasing wind farm energy production as set forth in claim 3
wherein each of the rotor blade tips is fitted with tangentially directed micro thruster powered by natural gas or any suitable liquid fuel.

5. Hybrid wind turbine apparatus as set forth in claim 4
wherein a rotary fluid coupler connects a stationary fuel line to a rotating fuel conduit firmly fixed to said rotating hallow shaft.

6. A method of generating power as set forth in claim 4 further including the steps of:
(a) providing each of the rotor blades with a radial passage extending from an inlet at the inner peripheral surface of the shaft to a tangentially directed outlet at the tip end;
(b) providing an axially extending duct through the shaft;
(c) providing a centrifugal fan to circulate ambient air around armature for cooling means and permitting the air to flow through the annular passage and redirecting the air flow through the inlet to the radial passage of each of the rotor blades;
(h) providing micro thrusters at the tip of each blade; and
(i) providing fuel source to the thruster during low wind periods.

7. A method of generating power as set forth in claim 4 including the step of:
drawing off the electrical power from the hub assembly to a distant receiver.
